(19) United States
(12) Patent Application Publication
(10) Pub. No.: US 2009/0280682 A1
(43) Pub. Date: Nov. 12, 2009

(54) COAXIAL CONNECTOR HAVING AN INSULATIVE BRACKET

(75) Inventors: XIAO-GUO ZHANG, Kunshan (CN); QING-MAN ZHU, Kunshan (CN); XUE-LIANG ZHANG, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/436,792

(22) Filed: May 7, 2009

(30) Foreign Application Priority Data
May 7, 2008 (CN) 200820300680.9

(51) Int. Cl. H01R 9/05

(52) U.S. Cl. 439/578

(57) ABSTRACT

A coaxial connector (1) mounted on a panel includes an insulative bracket (10) extending along a longitudinal axis thereof, a metallic member (20) disposed in the insulative bracket, and a contact terminal (30) assembled in the insulative bracket. The insulative bracket has a securing portion (13) defining a passage (130) and a connecting portion (14) surrounding the securing portion for mechanically connecting with a mating electrical connector. The metallic member is disposed between the securing portion and the connecting portion and has a mating portion (22) for electrically connecting with the mating electrical connector. The contact terminal is secured in the passage of the securing portion.

### BACKGROUND OF THE INVENTION

1. Field of the Invention

The present invention relates to a coaxial connector mounted on a panel and electrically connected with a mating electrical connector, and more particularly to a coaxial connector having an insulative bracket instead of metallic shell for mechanically connecting with a mating electrically connector.

2. Description of the Prior Art

Chinese Publication Patent No. CN 1835299A filed on Mar. 1, 2006 discloses a coaxial connector electrically terminated with a coaxial cable. The coaxial connector includes a metallic bracket defining a receiving space therein, a contact terminal assembled in the receiving space of the bracket via a first insulative bracket, and a second insulative bracket assembled to the outer surface of the metallic bracket for mounting on a panel.

In generally, the metallic bracket is made of metallic material by a turning process on a screw machine or a casting process. The metallic bracket should does have enough length and thickness for mechanically connecting with a mating electrically connector. Nevertheless, it requires a great quantity of metallic materials for turning or casting, so the cost of manufacturing the coaxial connector is inevitably high.

Hence, an improved coaxial connector is needed to solve the above problem.

### BRIEF SUMMARY OF THE INVENTION

An object of the present invention is to provide a coaxial connector having an insulative bracket instead of metallic shell for mechanically connecting with a mating electrically connector.

In order to achieve the object set forth, a coaxial connector mounted on a panel includes an insulative bracket extending along a longitudinal axis thereof, a metallic member disposed in the insulative bracket, and a contact terminal assembled in the insulative bracket. The insulative bracket has a securing portion defining a passage and a connecting portion surrounding the securing portion for mechanically connecting with a mating electrical connector. The metallic member is disposed between the securing portion and the connecting portion and has a mating portion for electrically connecting with the mating electrical connector. The contact terminal is secured in the passage of the securing portion.

Advantages of the present invention are to provide a coaxial connector having an insulative bracket having a connecting portion for mechanically connecting with a mating electrical connector. Therefore, the length and the thickness of the metallic member have been reduced, and the cost of manufacturing the coaxial connector is economically benefited.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is an assembled perspective view of a coaxial connector in accordance with the present invention;

FIG. 2 is a cross-sectional view of the coaxial connector as shown in FIG. 1, taken along line 2-2;

FIG. 3 is a perspective view of a metallic member of the coaxial connector as shown in FIG. 2;

FIG. 4 is another perspective view similar to FIG. 3, taken from another aspect; and

FIG. 5 is a cross-sectional view of the coaxial connector as shown in FIG. 1 when the coaxial connector is mounted on a panel, with a nut mounted on the coaxial connector.

### DETAILED DESCRIPTION OF THE INVENTION

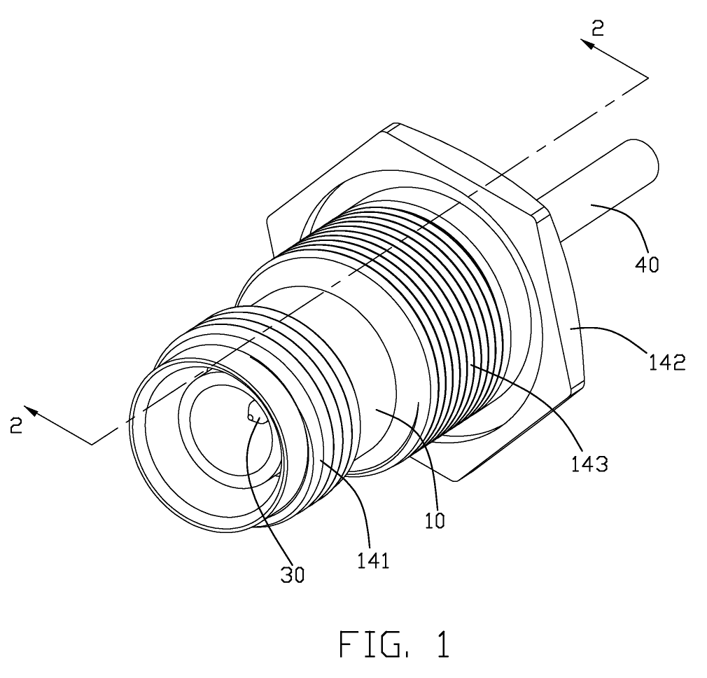

Reference will now be made to the drawing figures to describe the present invention in detail. Referring to FIGS. 1-5, a coaxial connector 1 in accordance with the present invention includes an insulative bracket 10, a metallic member 20 mounted in the insulative bracket 10, a contact terminal 30 received in the insulative bracket 10, and a cable 40 terminated with the contact terminal 30.

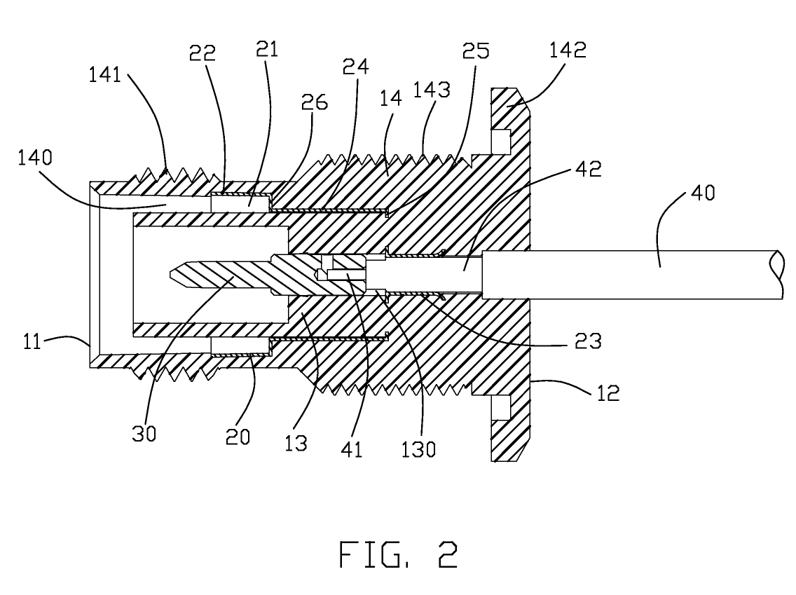

Referring to FIGS. 1 and 2, the insulative bracket 10 extends along a longitudinal axis and has a front end 11 and a rear end 12 opposite to the front end 11. The insulative bracket 10 has a securing portion 13 defining a first passage 130 for receiving the contact terminal 30 and a connecting portion 14 surrounding the securing portion 13 and defining a second passage 140 for receiving the metallic member 20. The securing portion 13 is integrally formed with the connecting portion 14 by a molding process. The connecting portion 14 has a first connecting portion 141 formed adjacent to the front end 11 for mechanically connecting with a mating electrical connector (not shown), a flange portion 142 formed on the rear end 12, and a second connecting portion 143 formed between the first connecting portion 141 and the flange portion 142.

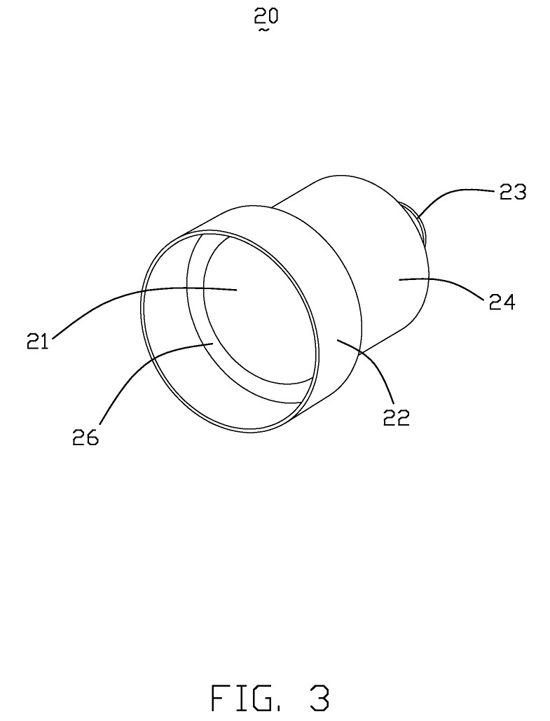

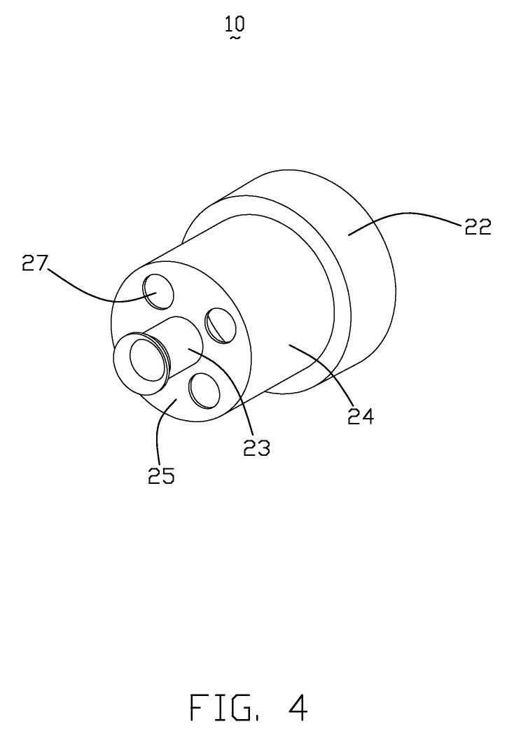

Referring to FIGS. 3 and 4, the metallic member 20 is made of metallic material by a drawing process. The metallic member 20 is disposed in the second passage 140 of the insulative bracket 10 and surrounded by the connecting portion 14 of the insulative bracket 10. The metallic member 20 is of a cylindrical shape defining a receiving space 21 therein for receiving the securing portion 13 of the insulative bracket 10. The metallic member 20 has a mating portion 22 formed thereon for electrically connecting with the mating electrical connector, a tube portion 23 opposite to the mating portion 22 for electrically connecting with the coaxial cable 40, and a middle portion 24 disposed between the mating portion 22 and the tube portion 23. The tube portion 23 has a first diameter, the middle portion 24 has a second diameter larger than the first diameter of the tube portion 23, and the mating portion 22 has a third diameter larger than the second diameter of the middle portion 24. The tube portion 23 interconnects with the middle portion 24 via a first step 25, and the middle portion 24 interconnects with the mating portion 22 via a second step 26. The first step 25 has a plurality of through holes 27 defined thereon. Molten plastic is injected into the receiving space 21 of the metallic member 20 via the through holes 27 to form the securing portion 13 of the insulative bracket 10.

Referring to FIG. 2, the coaxial cable 40 includes an inner conductor 41, a common shielding 42 and an insulative material (not labeled) disposed therebetween. The inner conductor 41 of the coaxial cable 40 extends through the tube portion 23 of the metallic member 20 into the first passage 130 of the insulative bracket 10 for electrically terminating with the contact terminal 30. The common shielding 42 is electrically connected with the tube portion 23 of the metallic member 20.

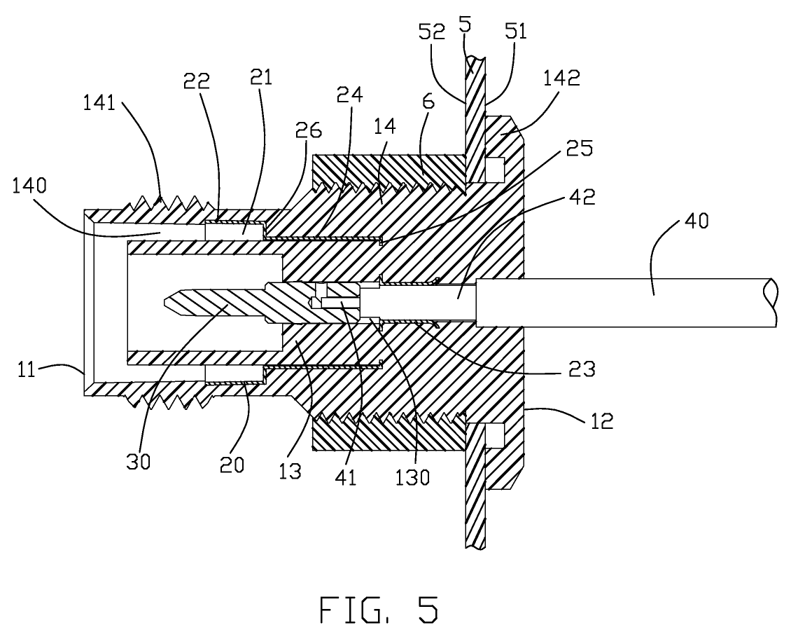

Referring to FIG. 5, when assemble the coaxial connector 1 to a panel 5 defining a first surface 51 and a second surface 52 opposite to the first surface 51, the coaxial connector 1 is inserted through an opening (not shown) defined on the panel 5, and the flange portion 142 abutting against the first surface 51 of the panel 5. Then a nut 6 is assembled onto the mounting portion 22 of the insulative bracket 20 for mechanically connecting with the second connecting portion 143 and abutting against the second surface 52 of the panel 5.

The coaxial connector 1 includes an insulative bracket 10 having a first connecting portion 141 for mechanically connecting with a mating electrical connector. Therefore, the length and the thickness of the metallic member 20 have been reduced, and the cost of manufacturing the coaxial connector 1 is economically benefited.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A coaxial connector mounted on a panel, comprising:
an insulative bracket extending along a longitudinal axis thereof and having a securing portion defining a passage, and a connecting portion surrounding the securing portion for mechanically connecting with a mating electrical connector;
a contact terminal secured in the passage of the securing portion; and
a metallic member disposed between the securing portion and the connecting portion, the metallic member having a mating portion for electrically connecting with the mating electrical connector.

2. The coaxial connector as claimed in claim 1, wherein said insulative bracket has a front end and a rear end, and the connecting portion has a first connecting portion formed adjacent to the front end, a flange portion formed on the rear end and a second connecting portion formed between the first connecting portion and the flange portion.

3. The coaxial connector as claimed in claim 1, further comprising a coaxial cable electrically connected with the contact terminal, the coaxial cable having an inner conductor and a common shielding surrounding the inner conductor.

4. The coaxial connector as claimed in claim 3, wherein said metallic member comprises a tube portion opposite to the mating portion for electrically connecting with the common shielding of the coaxial cable, and a middle portion disposed between the mating portion and the tube portion.

5. The coaxial connector as claimed in claim 4, wherein said tube portion has a first diameter, the middle portion is of a cylindrical shape and has a second diameter larger than the first diameter, and the mating portion is of a cylindrical shape and has a third diameter larger than the second diameter.

6. The coaxial connector as claimed in claim 5, wherein said tube portion interconnects with the middle portion of the metallic member via a first step, and the middle portion interconnects with the mating portion via a second step.

7. The coaxial connector as claimed in claim 6, wherein said first step has at least one through hole communicating with the receiving space, molten plastic injected into the receiving space of the metallic member via the through hole to form the securing portion of the insulative bracket.

8. The coaxial connector as claimed in claim 1, wherein said metallic member is made of metallic material by a drawing process.

9. The coaxial connector as claimed in claim 1, wherein said securing portion is integrally formed with the connecting portion by a molding process.

10. A coaxial connector comprising:
a metallic member defining a receiving space therein and having a mating portion formed thereon;
an insulative bracket having a securing portion received in the receiving space of the metallic member and defining a passage, and a connecting portion integrated with the securing portion and surrounding the metallic member, the connecting portion projecting forward from the mating portion of the metallic member; and
a contact terminal received in the passage of the securing portion of the insulative bracket.

11. The coaxial connector as claimed in claim 10, said metallic bracket has at least one through hole communicating with the receiving space, insulative material injected into the receiving space of the metallic member via the through hole to form the securing portion of the insulative bracket.

12. The coaxial connector as claimed in claim 10, wherein said insulative bracket has a front end and a rear end, the connecting portion has a first connecting portion formed adjacent to the front end, a flange portion formed on the rear end and a second connecting portion formed between the first connecting portion and the flange portion.

13. A coaxial connector for mating with a complementary connector, comprising:
a one piece insulative bracket defining the coaxial inner and outer tubular sections in a front portion thereof, said inner tubular section defining a mating port;
a metallic member secured within said bracket and defining a mating portion for mating with the complementary connector, and an engaging portion behind the mating portion;
a contact disposed along a center axis of the bracket and having a contact section in the mating port for mating with the complementary connector; and
a cable forward extending along said center axis into the bracket, and defining an inner conductor mechanically and electrically connected to the contact, and an outer conductor mechanically and electrically connected to the engaging portion.

14. The coaxial connector as claimed in claim 13, wherein the mating portion of the metallic member is located on one of an inner surface of the outer tubular section and an outer surface of the inner tubular section.

15. The coaxial connector as claimed in claim 13, wherein said mating portion is intimately located on the inner surface of the outer tubular section.

16. The coaxial connector as claimed in claim 13, wherein said metallic member defines a telescopic configuration under condition that the mating portion defines a large diameter thereof and the engaging portion defines a small diameter thereof.

17. The coaxial connector as claimed in claim 13, wherein said outer tubular section defines a first exterior thread region.

18. The coaxial connector as claimed in claim 17, wherein said bracket defines a second exterior thread region behind the first exterior thread region.

19. The coaxial connector as claimed in claim 18, wherein a diameter of said first exterior thread region is smaller than that of the second exterior thread region.

20. The coaxial connector as claimed in claim 13, wherein a front portion of said cable is embedded and secured in the bracket.
